(19) United States
(12) Patent Application Publication
(10) Pub. No.: US 2018/0373396 A1
(43) Pub. Date: Dec. 27, 2018

(54) THEME DATA

(71) Applicant: Atom Bank PLC, Durham (GB)

(72) Inventor: Mark MULLEN, Durham (GB)

(21) Appl. No.: 16/063,516

(22) PCT Filed: Dec. 23, 2016
(86) PCT No.: PCT/GB2016/054055

§ 371 Date: Jun. 18, 2018

(30) Foreign Application Priority Data
Dec. 24, 2015 (GB) 1522912.3

(51) Int. Cl. G06F 3/0481; G06F 3/16; G06F 3/01; G06Q 40/02; G06F 17/30

(52) U.S. Cl. CPC G06F 3/0481; G06F 3/16; G06F 17/30994; G06Q 40/02; G06F 3/016

(57) ABSTRACT

A method and a system for displaying account data are disclosed. The system comprises an application server on which is running application software maintaining a user account and a mobile device on which is running an app. The app is arranged to control the mobile device to generate an interface comprising a plurality of discrete graphical elements, said graphical elements displayed on the interface, said app further arranged to receive account data from the application server and to display data on each graphical element associated with the account data. The system further comprises a theme module arranged to communicate appearance data to the app, the app being arranged to control the mobile device to process the appearance data and modify an appearance of the interface in accordance with the appearance data.

### TECHNICAL FIELD

The present invention relates to techniques for displaying an interface generated by an app running on a mobile device. In particular, the present invention relates to technique for modifying the appearance of such an interface in accordance with theme data communicate from a theme module.

### BACKGROUND

Many mobile devices, such as smartphones, allow users to install additional computer programs (sometimes referred to as “apps”) onto their mobile devices. The purposes of such apps can be varied for example gaming apps, fitness tracking apps, messaging apps and so on.

Many service providers such as banks, utilities providers, telecommunication providers and so on, develop and distribute apps that enable their customers to access information about their accounts. Such apps typically provide an interface on which is shown information about a particular customers account such as service usage, account balance, past payments, future payments and so on.

These apps typically have a conventional web page type design where a number of pages are provided, each showing a different set of information. Aspects of conventional website design may be included such as drop down menus allowing users to select particular options, “forms” text entry boxes allowing users to enter information and “radio buttons”.

Whilst such design techniques are widely used for service provider app design, they do not necessarily take advantage of graphical functionality possible with modern mobile devices such as smartphones.

### SUMMARY OF THE INVENTION

In accordance with a first aspect of the invention, there is provided a system for displaying account data said system comprising an application server on which is running application software maintaining a user account and a mobile device on which is running an app. The app is arranged to control the mobile device to generate an interface comprising a plurality of discrete graphical elements. The plurality of discrete graphical elements are displayed on the interface. The app is further arranged to receive account data from the application server and to display data on each graphical element associated with the account data. The system further comprises a theme module arranged to communicate appearance data to the app, the app being arranged to control the mobile device to process the appearance data and modify an appearance of the interface in accordance with the appearance data.

Optionally, the theme module is implemented on the application server.

Optionally, the appearance data comprises graphical element appearance data and the app is arranged to control the mobile device to modify an appearance of the interface by modifying an appearance of one or more of the plurality of graphical elements in accordance with the graphical element appearance data.

Optionally, the appearance data comprises backdrop appearance data and the app is arranged to control the mobile device to modify an appearance of the interface by modifying an appearance of one or more backdrops of the interface in accordance with the backdrop appearance data.

Optionally, the appearance data comprises transition appearance data and the app is arranged to control the mobile device to modify an appearance of the interface by modifying an appearance of one or more transitions between different screens displayable on the interface in accordance with the transition appearance data.

Optionally, the graphical element appearance data comprises data relating to one or more of graphical element shape, graphical element size, graphical element colours or an image associated with a graphical element.

Optionally, the data associated with the account data and displayed on each graphical element comprises text data.

Optionally, the graphical elements are 3D graphical objects.

Optionally, the graphical elements are displayable as moveable on the interface in accordance with a predefined set of physics laws.

Optionally, the theme module is arranged to communicate physics control data to the app, the app being arranged to control the mobile device to process the physics control data and change physics laws in accordance with the physics control data.

Optionally, the theme module is arranged to communicate audio feedback data and/or haptic feedback data to the app, the app being arranged to control the mobile device to process the audio feedback data and/or haptic feedback data and control the mobile device to generate corresponding audio and/or haptic feedback in accordance with the audio feedback data and/or haptic feedback data.

Optionally, the mobile device is a smartphone.

Optionally, the application server is a banking application server and the app is a mobile banking app.

In accordance with a second aspect of the invention, there is provided a method of displaying graphical elements on an interface provided by an app running on a mobile device, said app arranged to control the mobile device to generate an interface comprising a plurality of discrete graphical elements and display on the interface the plurality of discrete graphical elements; receive account data from an application server and to display data on each graphical element associated with the account data; receive appearance data from a theme module; process the appearance data, and modify an appearance of the interface in accordance with the data.

Optionally, the theme module is implemented on the application server.

Optionally, the appearance data comprises graphical element appearance data and the app is arranged to control the mobile device to modify an appearance of the interface by modifying an appearance of one or more of the plurality of graphical elements in accordance with the graphical element appearance data.

Optionally, the appearance data comprises backdrop appearance data and the app is arranged to control the mobile device to modify an appearance of the interface by modifying an appearance of one or more backdrops of the interface in accordance with the backdrop appearance data.

Optionally, the appearance data comprises transition appearance data and the app is arranged to control the mobile device to modify an appearance of the interface by modifying an appearance of one or more transitions between different screens displayable on the interface in accordance with the transition appearance data.

Optionally, the graphical element appearance data comprises data relating to one or more of graphical element shape, graphical element size, graphical element colours or an image associated with a graphical element.

Optionally, the data associated with the account data and displayed on each graphical element comprises text data.

Optionally, the graphical elements are 3D graphical objects.

Optionally, the app is arranged to control the mobile device to display the graphical elements as moveable on the interface in accordance with a predefined set of physics laws.

Optionally, the method further comprises receiving from the theme module physics control data, the app being arranged to control the mobile device to process the physics control data and change physics laws in accordance with the physics control data.

Optionally, the method further comprises receiving from the theme module audio feedback data and/or haptic feedback data to the app, the app being arranged to control the mobile device to process the audio feedback data and/or haptic feedback data and control the mobile device to generate corresponding audio and/or haptic feedback in accordance with the audio feedback data and/or haptic feedback data.

Optionally, the mobile device is a smartphone.

Optionally, the application server is a banking application server and the app is a mobile banking app.

In accordance with a third aspect of the invention, there is provided a computer program which when run on a processor of a mobile device causes the mobile device to perform a method according to the second aspect of the invention.

In accordance with a fourth aspect of the invention, there is provided a computer program product on which is stored a computer program according to the third aspect.

App design for service provider apps providing users with information about their accounts typically uses conventional web page design elements such as pages, drop down menus, forms and so on. However, these conventional elements do not necessarily take advantage of graphical functionality possible with modern mobile devices such as smartphones.

In accordance with certain aspects of the invention, and in contrast with conventional arrangements a technique is provided whereby account data can be displayed on individual and discrete graphical elements of an interface generated by an app running on a mobile device. Further, and advantageously, appearance data communicated from a theme module can be communicated to the app to change an appearance of the interface. In this way, aspects of the appearance of the interface can be readily changed.

Various aspects and features of the invention are defined in the claims.

### BRIEF DESCRIPTION OF FIGURES

Certain embodiments of the present invention will now be described hereinafter, by way of example only, with reference to the accompanying drawings in which:

FIG. 1 provides a schematic diagram of a typical system for communicating data to an app running on a mobile device;

FIG. 2 provides a schematic diagram of a mobile device showing a graphical interface generated by an app running on the mobile device in accordance with certain embodiments of the invention;

FIG. 3 provides a schematic diagram illustrating how text data corresponding to account data maintained on a server is displayed using graphical elements on a mobile device in accordance with certain embodiments of the invention;

FIGS. 4a, 4b and 5 provide a schematic diagrams illustrating graphical elements displayed on interfaces in accordance with certain embodiments of the invention;

FIG. 6 provides a flow chart illustrating a process performed by an app running on a mobile device;

FIG. 7 provides a schematic diagram of a system for communicating data to an app running on a mobile device, the system including a theme module 701 in accordance with certain embodiments of the invention;

FIGS. 8a, 8b, 8c, 8d and 8e show examples of the appearance of graphical elements being changed based on theme data being communicated from a theme module to an app running on a mobile device in accordance with certain embodiments of the invention, and

FIG. 9 provides a flow chart illustrating a process performed by an app running on a mobile device in accordance with certain embodiments of the invention.

In the drawings like reference numerals refer to like parts.

### DETAILED DESCRIPTION

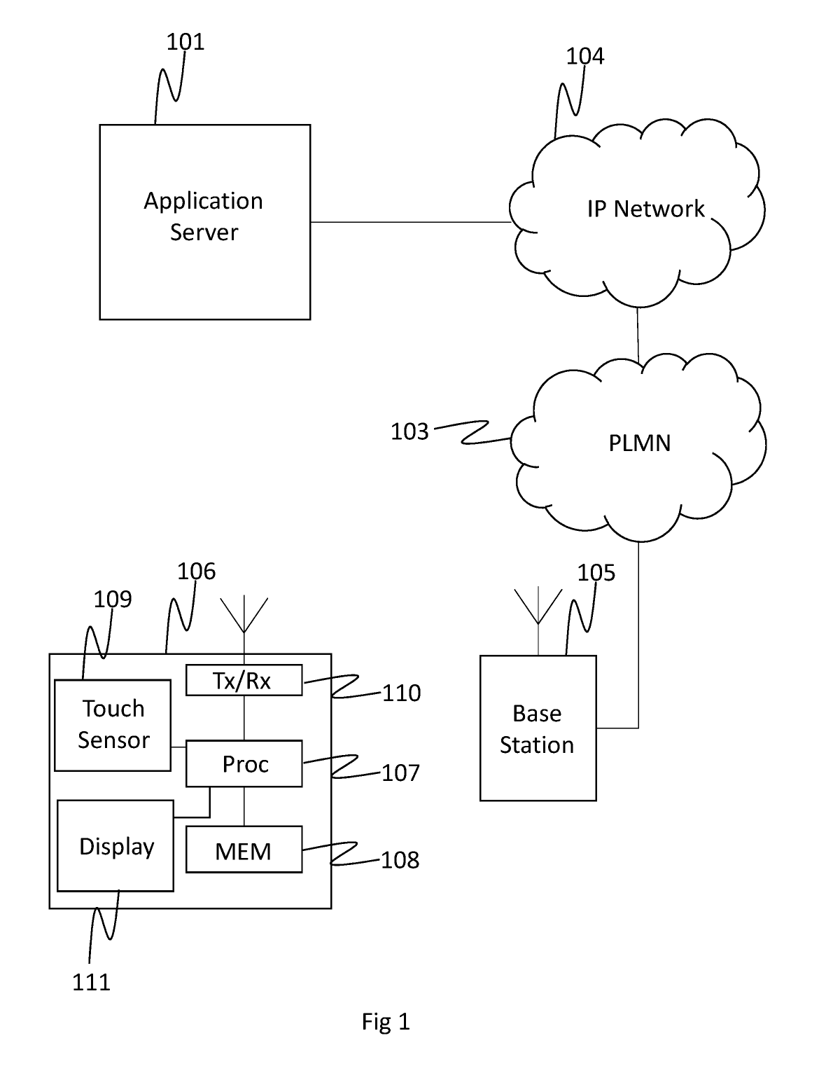

FIG. 1 provides a simplified schematic diagram of a typical system for communicating data to and from an app running on a mobile device and in which certain embodiments of the invention can be implemented. An application server 101 is controlled by a service provider and has running thereon application software which provides account based services to a number of users. The application software maintains account data for each user relating to aspects of their account. The account data relates to account information such as service usage, account status details of account events, details about projected account events that have yet to occur and so on.

The application server 101 is connected via an IP data network 104, such as the internet, and a PLMN (Public Land Mobile Network) 103, and a base station 105 of the PLMN 103, to a mobile device 106, such as a smartphone. Data can be communicated to and from the mobile device 106 and the application server 101 via the IP network 104 and the PLMN 103 using techniques known in the art. As is known, such techniques allow data to be communicated to specific mobile devices, irrespective of location, providing the devices are connected to the IP data network 104. As will be understood, any suitable network infrastructure can be used to communicate data between the application server 101 and the mobile device 106 (for example a “Wi-Fi” wireless access point connected to a network router connected to the IP data network 104).

The mobile device 106 includes a transceiver 110 for communicating to and from the base station 105, a processor unit 107, a memory 108, a display 111 and a touch sensor 109 for detecting user touch input. Typically the display 111 and the touch sensor 109 are integrated into a single unit, e.g. a “touchscreen”.

The memory 108 of the mobile device 106 has stored thereon a computer program (an app) provided by the service provider which when run on the processor unit 107 communicates data to and receives data from the application software running on the application server 101. The app, in conjunction with the application software running on the application server enables data relating to a user's account (account data), to be downloaded to the mobile device 106 and information associated with this account data to be displayed on the display 111.

In certain examples, the service provider is a financial organisation such as a bank and the application server is a banking application server, the application software is banking application software and the app is a banking app (sometimes referred to as a mobile banking app). The application software provides banking services to a user as is known in the art, for example enabling payments to be made to a user's account and authorising and facilitating payments to be taken from a user's account and so on.

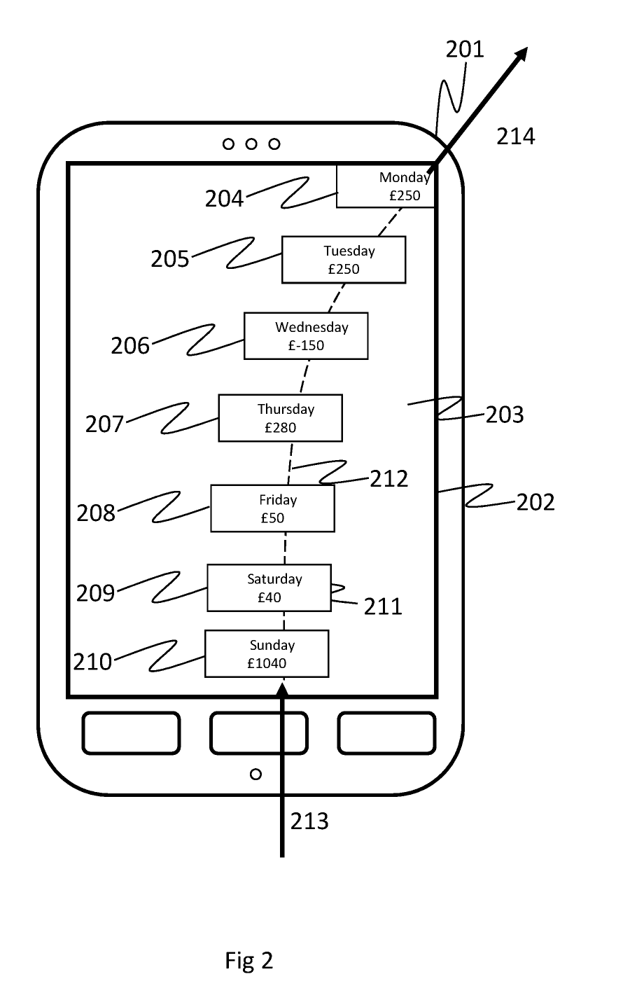

An example of account information associated with account data being displayed on the display of a user device is shown in more detail in FIG. 2.

FIG. 2 provides a schematic diagram of a mobile device 201, corresponding to the mobile device explained with reference to FIG. 1, with a touchscreen display 202. The mobile device 201 has running thereon a banking app. The banking app controls the mobile device to generate a graphical interface 203 which shows information relating to the user's bank account. The interface 203 can be controlled by the user, for example with touch gestures input to the touchscreen display, allowing the user to control what is displayed and input relevant information (e.g. password data or other authentication information, user account preferences to be communicated back to the application server and so on).

The interface 203 includes a number of graphical elements 204-210. The graphical elements 204-210 are typically discrete graphical objects which can be generated and displayed separately from one another. In certain examples, the graphical elements are stored and processed separately by the app as different data structures. Each data structure defines the various properties of a graphical element such as its dimensions, shape, colour and so on.

In the example shown in FIG. 2, each graphical element 204-210 includes a text data area where text data 211 can be displayed.

In the example shown in FIG. 2, the graphical elements 204-210 each display text data based on account data received from a banking application server. Each graphical element is associated with a particular chronological period of time (e.g. a day) and the text data relates to a particular account status associated with that period of time. For example, the account status relates to financial balance data indicating an amount of money in a user's account at the end of the particular chronological period with which the graphical element is associated.

Further, the graphical elements are arranged in chronological order. That is the graphical elements are distributed on the interface 203 in an order which corresponds with the order of the chronological periods associated with the financial balance data (different account statuses) shown on the graphical elements. In this way, a user can readily comprehend how the financial balance of their account has varied over a number of days.

During operation a user can input control actions, for example in the form of touch gestures, to the touchscreen 202 of the mobile device 201. Such touch gestures include scrolling gestures responsive to which the app controls the interface to “scroll” the display of the graphical elements. During such a scroll, the graphical elements form a scrollable group of graphical elements that move (transition across the interface) in conjunction with each other.

For example, the display of the graphical elements are transitioned in a particular direction (for example up or down). If, during a scroll, a particular graphical element reaches the top of the interface display area of the interface 203, it is partially displayed until it transitions off the top of the interface and is no longer displayed. Correspondingly, previously undisplayed graphical elements can be transitioned onto the interface display area the direction of the scrolling action. For example, with reference to FIG. 2, in certain embodiments in the event of an upwards vertical scroll action input by a user, the graphical elements transition upwards along a scrolling arc 212 starting at the centre bottom of the interface and finishing at the top right corner of the interface 203. Previously undisplayed graphical elements transition onto the interface 203 in the direction indicated by the first arrow 213 and previously displayed graphical elements transition off the interface 203 in the direction indicated by the second arrow 214.

As will be understood, in this way a user can view their financial balance history over a period of time greater than the total period of time that can be represented by graphical elements on the interface at one time.

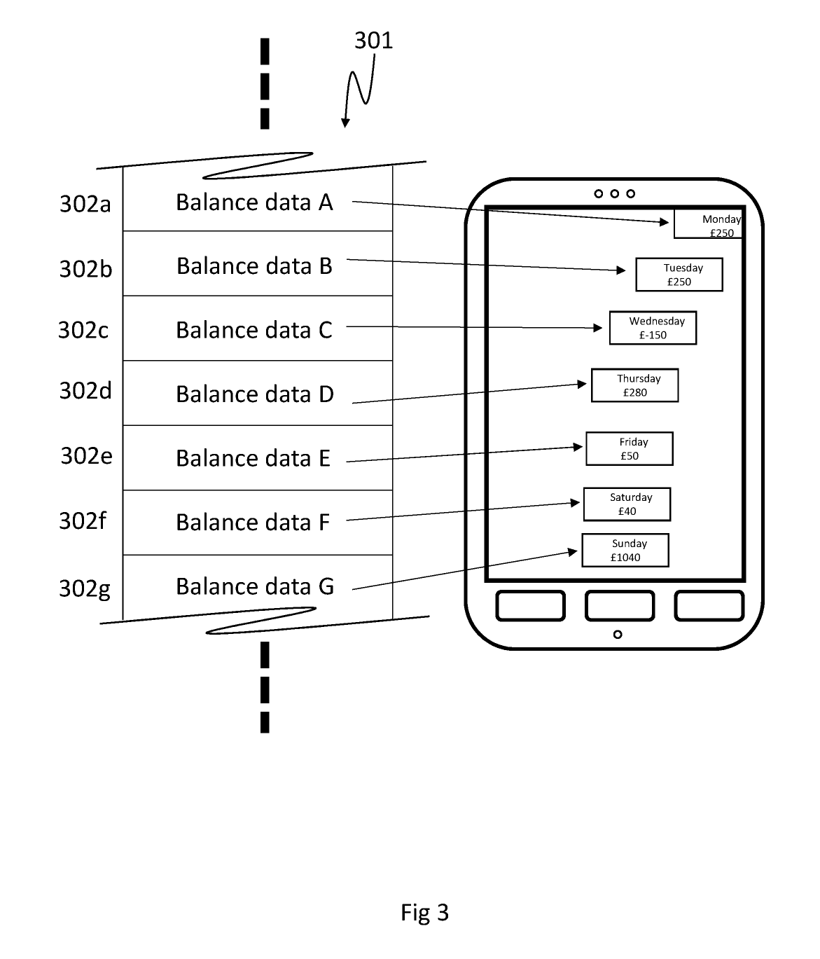

FIG. 3 provides a schematic diagram illustrating how text data associated with account data (and in particular account status data) maintained on the banking application server is displayed using graphical elements such as the graphical elements 204-210 shown in FIG. 2.

FIG. 3 illustrates part of a data structure 301 maintained in a banking application server. The data structure relates account status data for example account balance data relating to account statuses over a particular period of time.

The data structure contains a number of data records 302a-302g each of which contain data indicating an amount of money in a user's account at the end of a particular chronological period. During operation, balance data from the data structure 301 is communicated to the banking app on a mobile device and displayed on graphical elements of the banking app interface. As indicated by the arrows shown in FIG. 3, balance data from each data record 302a-302g is displayed in the form of text data on a graphical element. As will be understood, the data records illustrated in FIG. 3 relate to balance data over a particular time period (e.g. Sunday to Monday). In the event of a scroll action being performed as described above, balance data from other data records of the data structure 301 is communicated to the app for displaying corresponding text data relating to a different time period.

In certain examples the app is such that the interface is generated, at least partly, as a “3D environment”. That is, graphical elements can be represented as being “3D” (3D graphical objects), i.e. as being representations of three dimensional objects with length, width and depth (x,y,z) dimensions.

In certain examples, the 3D graphical elements can be represented in a 3D space i.e. with a horizontal “x axis” position, vertical “y axis” position, and a depth “z axis” position. A representation of the graphical elements position within the three dimensional space is generated on the interface.

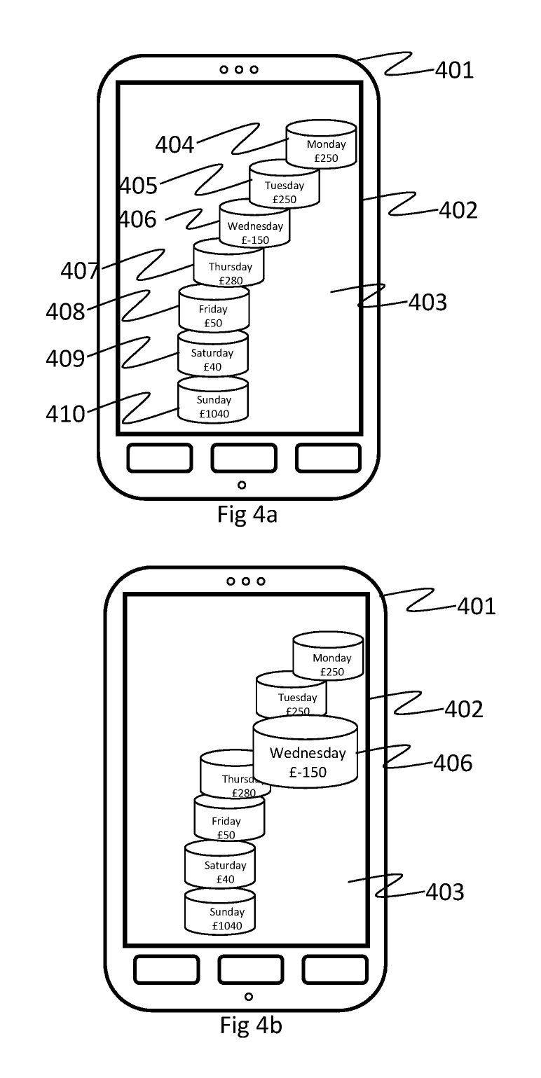

FIG. 4a provides a schematic diagram depicting a mobile device 401 with a touchscreen 402 on which is shown an interface 403 provided by an app in accordance with certain embodiments of the invention. The interface 403 shows graphical elements 404-410 corresponding to the graphical elements 204-210 explained with reference to FIG. 2 except that the graphical elements 404-410 are representations of three dimensional objects. In the example shown in FIG. 4a, the graphical elements have different x and y positions but have the same position on the z axis.

In certain examples, the app is arranged such that z axis position of a particular graphical element can be changed in order, for example, to emphasise that particular graphical element.

An example of this is shown in FIG. 4b. FIG. 4b shows that the third from top graphical element 406 has an adjusted z axis position, making it appear more prominent on the interface 403 than the other graphical elements.

In certain examples, this variation in the z axis value can be used to emphasise particular text data on the graphical element. For example, it may be desirable to highlight chronological periods in which the user's bank account goes “overdrawn”. The third from top graphical element 406 displays text data indicating a negative amount of money—i.e. at the end of the relevant chronological period (Wednesday) the user's bank account went overdrawn by an indicated amount (£150). Hence the z axis position of the third from top graphical element 406 is increased to make it more prominent.

In certain embodiments, the app is developed using a 3D development “engine”, such as the “Unity” games engine, thereby facilitating the 3D features discussed above.

In certain embodiments, graphical elements can be used to convey further information such as message data. For example, a banking service provider may wish to send a user a message relating to a particular product that may be of interest to the user, for example in response to a particular type of account event associated with their account.

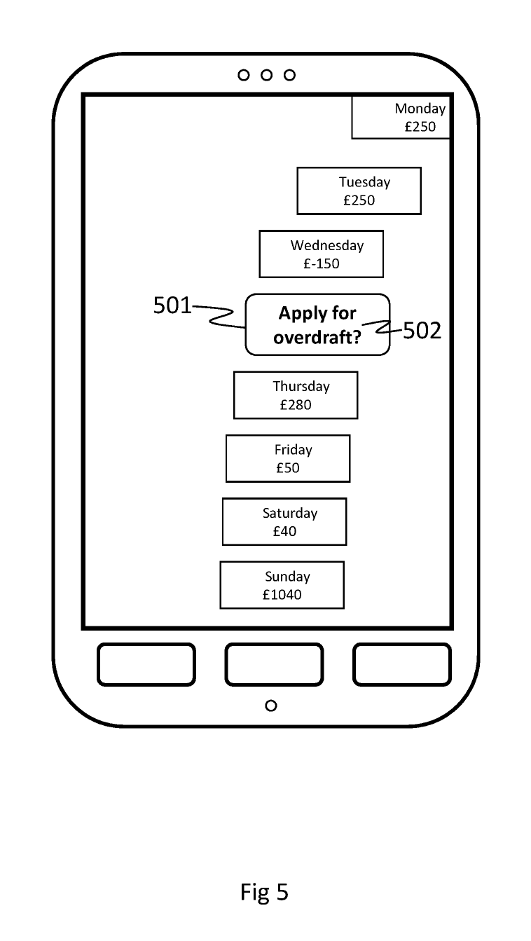

For example, in response to the account event of a user's bank account becoming overdrawn, the banking service provider may wish to offer the user the opportunity to apply for a preferential overdraft facility. Message data is communicated from the banking application server to the app on the user's mobile device. Text data associated with the message data is then displayed on a further graphical element which is displayed in the group of graphical elements. An example of this is shown in FIG. 5.

FIG. 5 provides a schematic diagram showing an interface on the touchscreen of a mobile device corresponding to that shown in FIG. 2. However, as can be seen in FIG. 5, a further graphical element 501 is shown showing text data 502 associated with message data from the banking application server.

In certain embodiments, responsive to a control input from a user (for example a gesture input selecting the further graphical element 501) one or more further graphical elements are displayed on the interface, allowing the user perform various steps in order to apply for the overdraft facility.

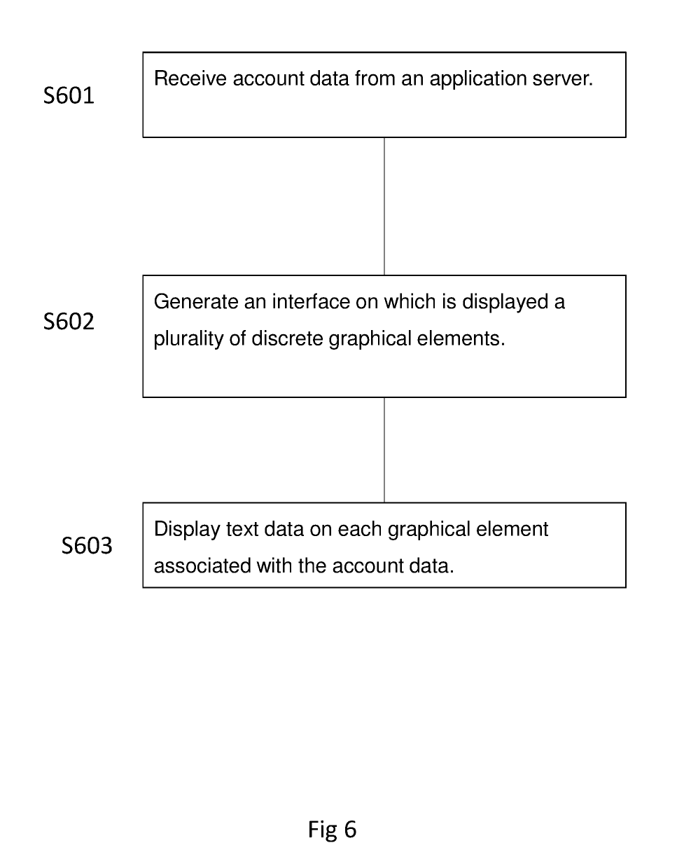

FIG. 6 provides a flow diagram of a process performed by an app running on a mobile device.

At a first step S601, an app running on a mobile device receives account data, relating for example to account status data, from an application server on which application software is running providing an account-based service for a user of the mobile device. At a second step S602, the app controls the mobile device to generate an interface on which is displayed a plurality of discrete graphical elements. At a third step S603 the app controls the mobile device to display text data associated with the account on each of the graphical elements.

As will be understood, the app running on the mobile device comprises computer-readable code which when run on the processor unit of the mobile device causes the processor to control the mobile device in accordance with the flow diagram of FIG. 6. Such a computer program can be stored on a suitable computer program product such as a CD-ROM or solid state memory device.

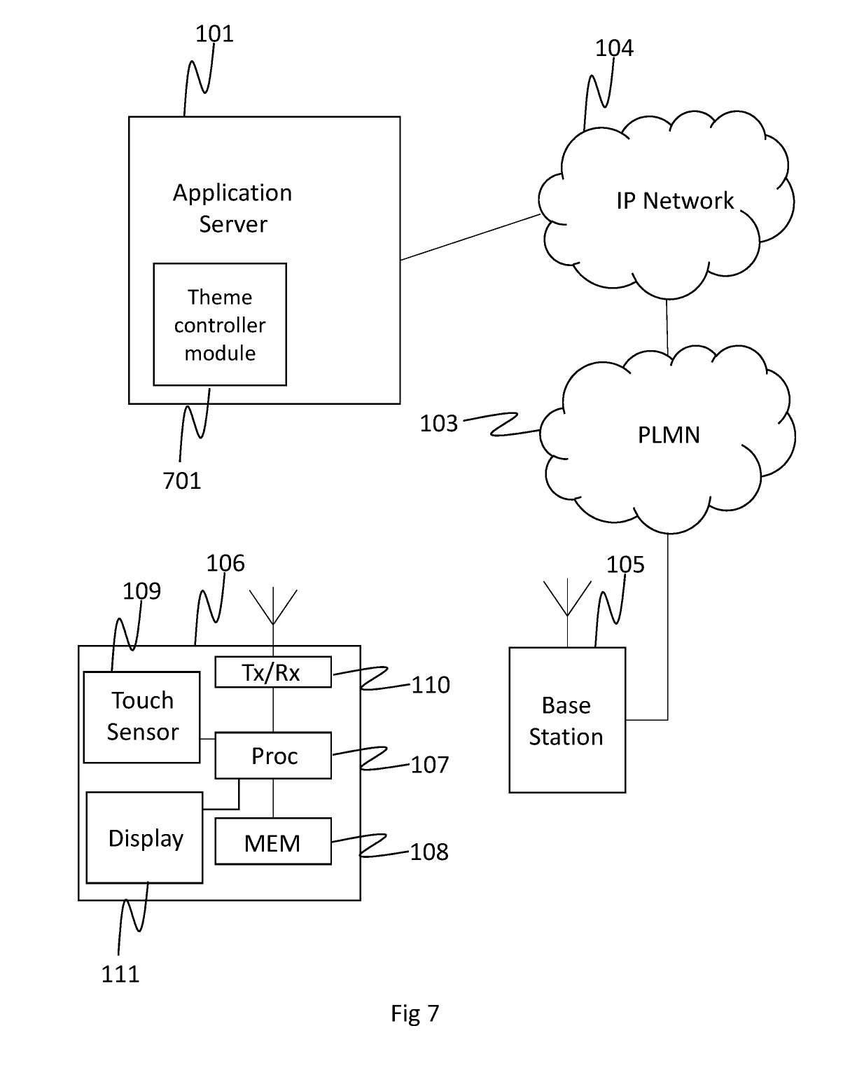

FIG. 7 provides a schematic diagram of a system corresponding to that shown in FIG. 1, except that the application server 101 is provided with a theme module 701.

The theme module 701 is arranged to communicate “theme” data to the app running on the mobile device which, when processed by the mobile device, can change aspects of the operation of the app. For example, the theme data may comprise appearance data which, when processed, changes aspects of the appearance of the interface generated by the app. For example, in certain embodiments, aspects of the appearance of the graphical elements displayed on the interface could be changed by the theme data. In such examples, the theme data would comprise graphical element appearance data.

In this way a service provider controlling the application server 101 can update the appearance of the interface of the app, or other aspects of the app. In certain embodiments this can be done in response to a user generated request. For example, the interface provided by the app may provide a control that allows a user to select one of a number of “themes” to customise the interface provided by the app. This arrangement may be similar to conventional “app-stores” that allow users to download additional content (such as apps, music content and video content) to devices such as smartphones.

In such an example, a number of “theme” options may be presented, for example based on different types of animals such as a cat theme, a dog theme, a fish theme and so on. Responsive to a user selecting a particular theme, theme selection data is communicated back to the application server from the app and theme data (for example graphical element appearance data) corresponding to the user selection is communicated from the theme module 701 to the app and the appearance of the interface, and the graphical elements in particular, are updated/changed accordingly.

In certain embodiments, theme data may be sent to an app running on a mobile device in response to other factors. For example, a location of a mobile device may be monitored using suitable techniques. For example the app may control the mobile device to periodically transmit location data back to the application server. This can be based on location data from a global navigation system sensor such as a GPS sensor on the mobile device, or inferred location information from a cell identity of one or more base stations of a PLMN with which the mobile device is communicating. On receiving location data indicating that a mobile device is in a particular location, the theme module can be arranged to communicate specific theme data. For example, if a mobile device was determined to be at a particular tourist attraction, e.g. a beach, theme data relating to a beach could be communicated to the mobile device.

In certain embodiments, a service provider may communicate theme data to an app on the mobile device without a request from a user. For example, if a particular event is occurring, the service provider may wish the interface to be updated to make reference to the event, i.e. to have a visual theme which is associated with the event.

For example, if a prominent sporting event is occurring, such as a football tournament, the appearance of the graphical elements could be changed to look like footballs or football boots. In another example, if the service provider wishes to advertise the products or services of another organisation, the appearance of the graphical elements can be changed to correspond with aspects of the branding (e.g. logos, pictures, text, colouring etc) of the other organisation.

In certain embodiments, the theme data comprises data that can determine aspects of how the graphical elements appear. This includes the shape, size, colour, pattern of the graphical elements and any images displayed on the graphical elements.

As discussed above, in certain embodiments, the graphical elements are stored and processed separately by the app as different data structures. Each data structure defines the properties of a graphical element including its appearance. It will be understood therefore, that the theme data can include graphical appearance data that can be readily incorporated into these data structures allowing the appearance of the graphical elements to be changed.

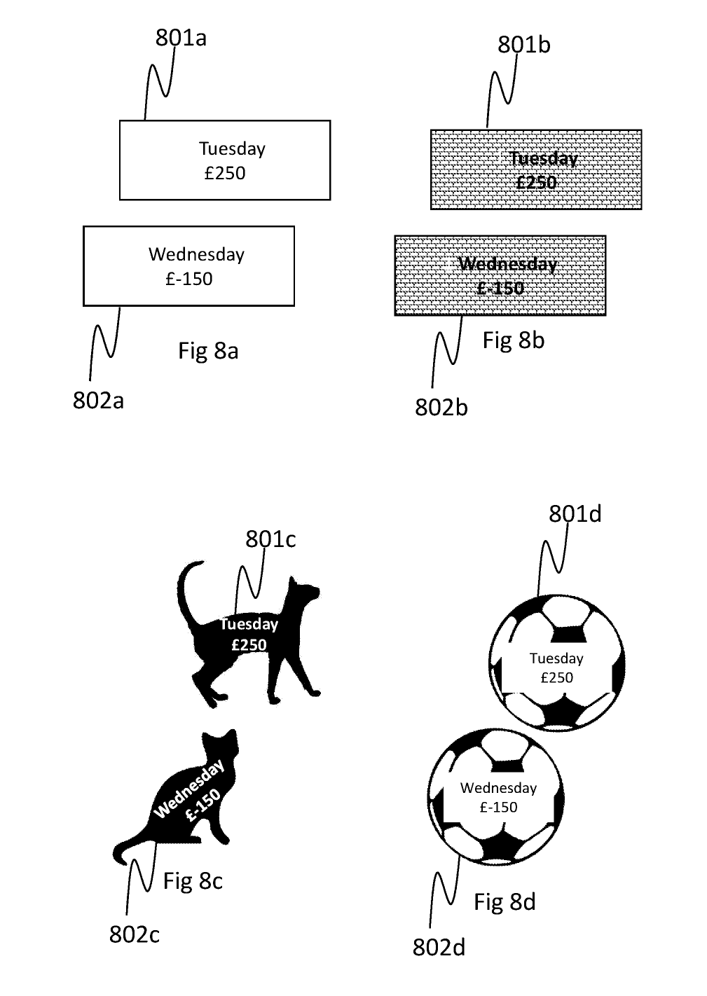

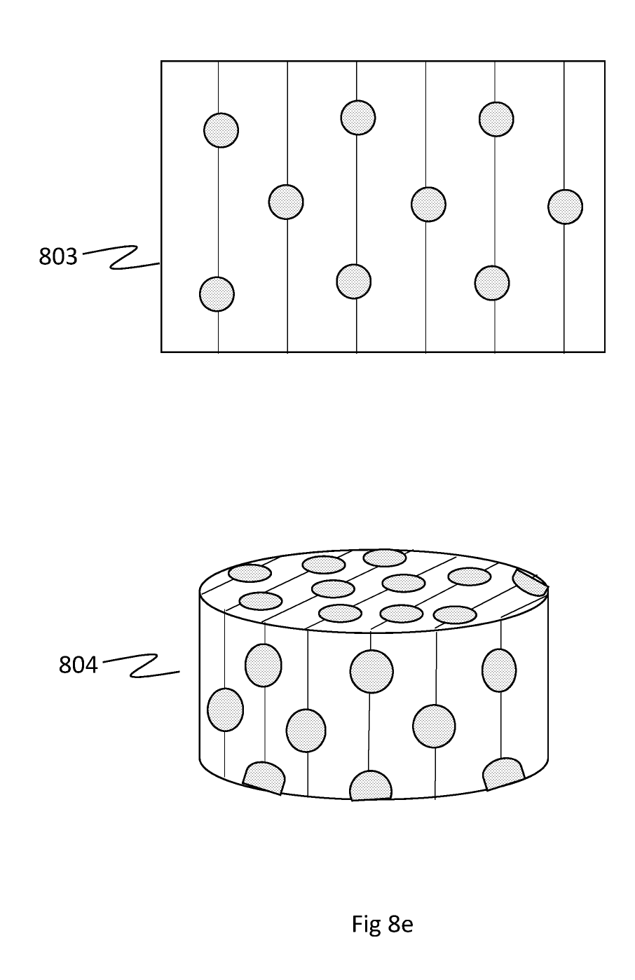

On receipt of theme data comprising data for modifying the appearance of the graphical elements, the app is arranged to process the theme data and modify an appearance of the graphical elements in accordance with the theme data. FIGS. 8a, 8b, 8c and 8d show examples of the appearance of graphical elements being changed based on theme data being communicated from the theme module to an app running on a mobile device.

FIG. 8a provides a schematic diagram depicting two graphical elements 801a, 802a corresponding to two of the graphical elements depicted for example in FIG. 2 (including text data 803, 804 as described previously) and displayed during operation of the app as described above.

FIG. 8b provides a schematic diagram depicting the same graphical elements 801b, 802b but after theme data has been communicated from the theme module changing the appearance of the graphical elements. In this example, the theme data comprises data relating to a background pattern of the graphical elements and as can be seen, a background pattern of the graphical elements 801b, 802b has changed.

FIG. 8c provides a further schematic diagram with graphical elements 801c, 802c in which theme data has been received relating to the shape and colouring of the graphical elements. Specifically, the theme data changes the appearance of the graphical elements to correspond to different silhouettes of cats. As discussed above, this may be responsive to a user choosing a “cat theme” from the interface provided by the app.

FIG. 8d provides a further schematic diagram with graphical elements 801d, 802d in which theme data has been received relating to an image associated with the graphical elements. Specifically, the theme data changes the appearance of the graphical elements such that each graphical element comprises an image of a football. As discussed above, this may be responsive to a service provider updating the appearance of the interface during a sporting event such as a football tournament.

As discussed above, the interface displays a plurality of graphical elements. Which graphical elements are displayed may change over time in response, for example, to a scrolling event occurring. The theme data may be such that the appearance of all the graphical elements displayed on the interface are changed or the theme data may be such that the appearance of only a subset of the graphical elements are changed, i.e. the appearance of only one or more selected graphical elements are changed.

In certain embodiments, if the theme data comprises appearance data, the appearance data may relate to a backdrop displayed on the interface. A backdrop (for example a static image, pattern, shape or colour) can be displayed in the “background” of the interface and on top of which the graphical elements of the interface are displayed.

In certain embodiments, the interface might have a number of different “screens” (sometimes referred to as “pages”), for example a welcome screen, a home screen, an account data screen and so on. In such embodiments, different backdrops may be displayed on different screens. In embodiments in which the theme data comprises appearance data, and specifically comprises backdrop appearance data, the app is arranged to modify the appearance of the interface in accordance with the backdrop appearance data received from the theme module by changing the appearance of a backdrop on one or more screens of the interface.

In certain embodiments, for example embodiments in which the interface includes a number of different screens, the app may display a transition graphic when a user controls the app to move between screens.

For example, a transition graphic could control the display of one screen to another by mimicking the turning of the page of a book, a movie-editing style transition such as a fade-in, fade-out or a “wipe”. In certain embodiments, for example where the backdrop of a screen of the interface is based on a fabric as described above, the transition graphic may be arranged to appear as if a fabric-like surface (for example table cloth) is being removed.

In such embodiments, the appearance data of the theme data may comprise transition appearance data. In such embodiments the app is arranged to process the transition appearance data and modify the transition graphic in accordance with the transition appearance data. In certain embodiments, an app may include more than one transition graphic (for example for differently transitioning between different screens). In such embodiments, the transition appearance data may relate to more than one transition graphic, and thus, when processed by the app, may modify more than one transition graphic.

In certain embodiments, for example where the theme data includes appearance data such as graphical element data, the theme data can relate to a “fabric”. The fabric can be based on a two-dimensional representation of an image, pattern, photo or similar. If the theme data comprises graphical element appearance data, the appearance data can relate to a specific fabric. When the graphical element data is received by the app, the app is arranged to modify the appearance of the graphical elements by applying the fabric to the graphical elements as a “skin”, e.g. displaying one or more graphical elements as if they are “wrapped” in the fabric. In embodiments in which the graphical elements are 3D objects, each visible surface of the 3D objects will thus be displayed with the two-dimensional representation of the fabric. Alternatively or additionally, backdrop appearance data can relate to a specific fabric and the backdrop of screens of the interface can be modified in accordance with the fabric.

FIG. 8e provides a schematic diagram depicting the concept of a fabric communicated in theme data being applied to a graphical element displayed on the interface generated by the app. FIG. 8e shows a fabric 803, in the form of a repeating pattern, being applied to a graphical element 804, such as the type of graphical element described with reference to FIGS. 4a and 4b.

As is known, in certain graphics environments, for example 3D graphics environments generated in accordance with 3D graphics engines such as the Unity games engine, movement of graphical elements of an interface can be displayed in accordance with predefined “physics laws”. For example, if a graphical element is attributed the property of a large mass, it might be shown to move more slowly than a graphical element attributed the property of a smaller mass. In another example, graphical elements may be attracted to each other in accordance with a predefined “force” analogous to a gravitational attraction.

In certain embodiments, the theme data may comprise physics control data. In such embodiments, the app is arranged to modify the physics laws of the interface in accordance with the physics control data.

In certain embodiments, during operation, the app may be arranged to control the device on which it is running to generate audio feedback (e.g. generate sound from a speaker of the device in response to a particular event) or to generate haptic feedback (e.g. generate a sequence of vibrations using a vibrating unit). In certain embodiments, the theme data may comprise feedback control data comprising audio feedback data and/or haptic feedback data. In such embodiments, the app is arranged to modify the way in which audio and/or haptic feedback is generated in accordance with the feedback control data (i.e. the audio feedback data and/or haptic feedback data).

In the examples described above the service provider controlling the application server shown for example in FIG. 7, controls the theme data in the theme module. However, in certain embodiments, an application program interface (API) may be provided to allow third parties to generate theme data which can be communicated to the theme module of the application server. This third party theme data can then be communicated to mobile devices as described above.

As will be understood, the system depicted in FIGS. 1 and 7 show only one mobile device. Typically, an application server will be arranged to communicate data to and receive data from many mobile devices. As mentioned above, in certain examples, the theme module 701 is arranged to communicate data to apps without any request from a user. In some examples, the theme module may be arranged to communicate the same theme data to all mobile devices on which the app is running. In other examples, theme data may be transmitted to one or more of a selected number of mobile devices based on particular criteria for example if users of the mobile devices in question have indicated that they wish to receive theme data and/or if it is known or determined that particular theme data might be relevant to one or more particular users. For example, one or more users may previously have indicated a desire to receive theme data relating to a particular subject. In the event that new theme data becomes available relating to that subject (for example a pop group or a sports team), then the relevant theme data is communicated to the apps running on mobile devices of those users.

In the example of the system shown in FIG. 7, the theme module is shown as being part of the application server. However, it will be understood that in certain embodiments the theme module can be implemented separately from the application server, for example in a different application server, for example a web server independent of the application server. In other examples, the functionality associated with the theme module (including communicating theme data to selected mobile devices running the app or to all devices running the app) can be distributed across several network entities, for example several servers.

As mentioned above, in certain examples the graphical elements are three-dimensional objects.

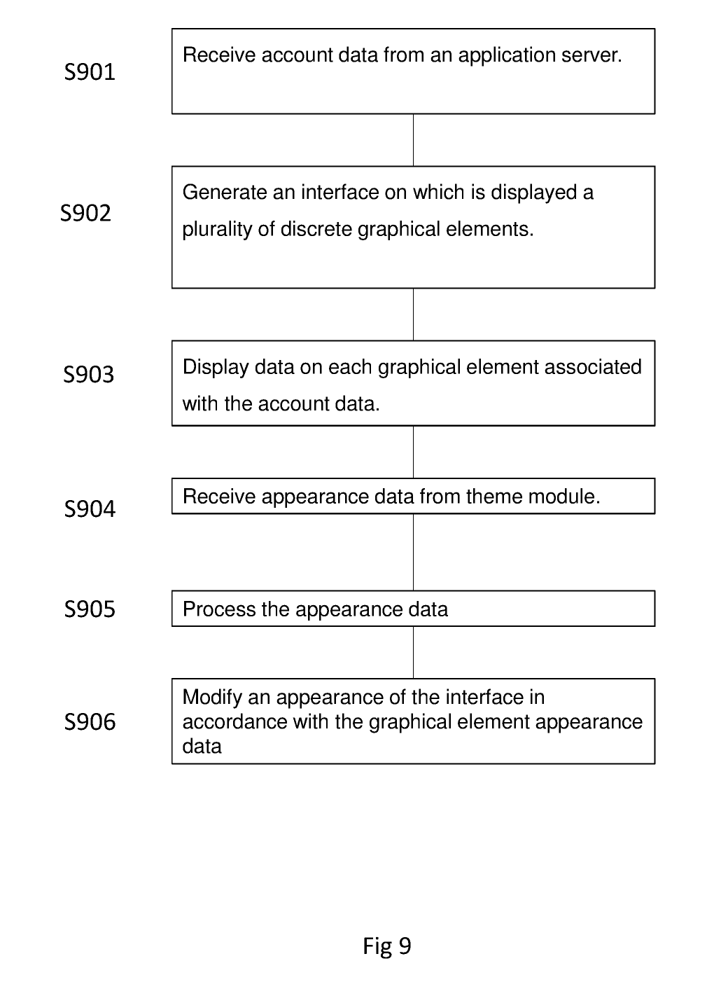

FIG. 9 provides a flow diagram of a process performed by an app running on a mobile device in accordance with certain embodiments of the invention.

At a first step S901, an app running on a mobile device receives account data, relating for example to account status data, from an application server on which application software is running providing an account-based service for a user of the mobile device.

At a second step S902, the app controls the mobile device to generate an interface on which is displayed a plurality of discrete graphical elements.

At a third step S903 the app controls the mobile device to data associated with the account on each of the graphical elements.

At a fourth step S904 appearance data is received by the app from a theme module, and a fifth step S905, the appearance data is processed by the app. At a sixth step, responsive to processing the appearance data, the appearance the interface, for example the appearance of one or more of the graphical elements, is modified in accordance with the appearance data.

It will be understood that the order of the steps indicated in FIG. 9 is not necessarily indicative of the order in which steps of the process in all embodiments of the invention are performed.

As will be understood, the app running on the mobile device comprises computer-readable code which when run on the processor unit of the mobile device causes the processor to control the mobile device in accordance with the flow diagram of FIG. 9. Such a computer program can be stored on a suitable computer program product such as a CD-ROM or solid state memory device.

The embodiments of the invention described above have been described mainly in terms of mobile devices, for example smartphones. It will be understood that the principles of the invention are not limited to smartphones but can be used with other suitable mobile devices including tablet computers, portable games consoles, media players and so on.

It will be understood that in certain instances, the description of the various systems provided above, for example the arrangement shown in FIG. 1, have been simplified for the sake of clarity. It will be understood that in examples in which, for example, the application server relates to a bank account being provided by a banking service provider, functionality associated with the application server is typically more complex than depicted, for example involving a more complex arrangement of several servers with further intermediate components or an arrangement of server systems. Further infrastructure, such as banking terminals and ATMs may also be linked to these servers/server systems. Moreover, the application server will perform many additional functions associated with mobile banking as well as those discussed in detail above, for example security functions ensuring that only authorised users can access account information.

Examples of the invention have been described above mainly in terms of a service provider providing a banking service. However, it will be understood that the embodiments of the invention can be used in the provision of any suitable account based service, for example utilities providers, telecommunications providers and so on. It will be understood that precise the nature of account data will depend on the nature of the account based service. For example, account data, and in particular account status data, relating to a utilities based provider might relate to usage of a utility like the consumption of gas or electricity over a particular period of time. Account data, and in particular account status data, relating to a telecommunications based provider might relate to usage of a telephone line over a particular period of time, including details of calls made and received and so on. Further it will be understood that the precise nature of “account events” will depend on the nature of the service provider. An account event associated with a utilities service provider might be a user consuming more than a predetermined amount of gas or electricity or a monthly bill exceeding a predetermined amount. An account event associated with a telecommunications provider might be a user exceeding a predetermined amount of time usage of a telephone line or a predetermined amount of downloaded data via a particular internet connection.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A system for displaying account data said system comprising an application server on which is running application software maintaining a user account and a mobile device on which is running an app,
said app arranged to control the mobile device to generate an interface comprising a plurality of discrete graphical elements, said graphical elements displayed on the interface, said app further arranged to receive account data from the application server and to display data on each graphical element associated with the account data, wherein
the system further comprises a theme module arranged to communicate appearance data to the app, the app being arranged to control the mobile device to process the appearance data and modify an appearance of the interface in accordance with the appearance data.

2. The system of claim 1, wherein the theme module is implemented on the application server.

3. The system of claim 1, wherein the appearance data comprises graphical element appearance data and the app is arranged to control the mobile device to modify an appearance of the interface by modifying an appearance of one or more of the plurality of graphical elements in accordance with the graphical element appearance data.

4. The system of claim 1, wherein the appearance data comprises backdrop appearance data and the app is arranged to modify an appearance of the interface by modifying an appearance of one or more backdrops of the interface in accordance with the backdrop appearance data.

5. The system of claim 1, wherein the appearance data comprises transition appearance data and the app is arranged to modify an appearance of the interface by modifying an appearance of one or more transitions between different screens displayable on the interface in accordance with the transition appearance data.

6. The system of claim 3, wherein the graphical element appearance data comprises data relating to one or more of graphical element shape, graphical element size, graphical element colors or an image associated with a graphical element.

7. (canceled)

8. (canceled)

9. The system of claim 1, wherein the graphical elements are displayable as moveable on the interface in accordance with a predefined set of physics laws.

10. The system of claim 9, wherein the theme module is arranged to communicate physics control data to the app, the app being arranged to process the physics control data and change physics laws in accordance with the physics control data.

11. The system of claim 1, wherein the theme module is arranged to communicate audio feedback data and/or haptic feedback data to the app, the app being arranged to process the audio feedback data and/or haptic feedback data and control the mobile device to generate corresponding audio and/or haptic feedback in accordance with the audio feedback data and/or haptic feedback data.

12. (canceled)

13. (canceled)

14. A method of displaying graphical elements on an interface provided by an app running on a mobile device, said app arranged to control the mobile device to generate an interface comprising a plurality of discrete graphical elements and displaying on the interface the plurality of discrete graphical elements;
receive account data from an application server and to display data on each graphical element associated with the account data;
receive appearance data from a theme module;
process the appearance data, and
modify an appearance of the interface in accordance with the data.

15. The method of claim 14, wherein the theme module is implemented on the application server.

16. The method of claim 14, wherein the appearance data comprises graphical element appearance data and the app is arranged to control the mobile device to modify an appearance of the interface by modifying an appearance of one or more of the plurality of graphical elements in accordance with the graphical element appearance data.

17. The method of claim 14, wherein the appearance data comprises backdrop appearance data and the app is arranged to control the mobile device to modify an appearance of the interface by modifying an appearance of one or more backdrops of the interface in accordance with the backdrop appearance data.

18. The method of claim 14, wherein the appearance data comprises transition appearance data and the app is arranged to control the mobile device to modify an appearance of the interface by modifying an appearance of one or more transitions between different screens displayable on the interface in accordance with the transition appearance data.

19. The method of claim 16 wherein the graphical element appearance data comprises data relating to one or more of graphical element shape, graphical element size, graphical element colors or an image associated with a graphical element.

20. (canceled)

21. The method of claim 14, wherein the graphical elements are 3D graphical objects.

22. The method of claim 14, wherein the app is arranged to control the mobile device to display the graphical elements as moveable on the interface in accordance with a predefined set of physics laws.

23. The method of claim 22, further comprising
receiving from the theme module physics control data, the app being arranged to control the mobile device to process the physics control data and change physics laws in accordance with the physics control data.

24. The method of claim 14, further comprising
receiving from the theme module audio feedback data and/or haptic feedback data to the app, the app being arranged to control the mobile device to process the audio feedback data and/or haptic feedback data and control the mobile device to generate corresponding audio and/or haptic feedback in accordance with the audio feedback data and/or haptic feedback data.

25. (canceled)

26. (canceled)

27. A computer program which when run on a processor of a mobile device causes the mobile device to perform a method according to claim 14.

28. (canceled)

29. (canceled)
